(19) United States
(12) Patent Application Publication
(10) Pub. No.: US 2018/0276754 A1
(43) Pub. Date: Sep. 27, 2018

(54) RANK PORTFOLIO MANAGEMENT SYSTEM

(71) Applicant: AKPOREFE AGBAMU, OAKDALE, MN (US)

(72) Inventor: AKPOREFE AGBAMU, OAKDALE, MN (US)

(73) Assignee: AHRVO, LLC, OAKDALE, MN (US)

(21) Appl. No.: 15/934,992

(22) Filed: Mar. 24, 2018

Related U.S. Application Data
(60) Provisional application No. 62/476,363, filed on Mar. 24, 2017.

(51) Int. Cl. G06Q 40/06; G06Q 10/06; G06F 15/18

(52) U.S. Cl. CPC G06Q 40/06; G06F 15/18; G06Q 10/06393

(57) ABSTRACT

The present invention provides a system for a non-seasoned user to make superior investment decisions by providing a system for the non-seasoned user to build an investment portfolio wherein the selection of the components is rules-based and ranked for effectiveness. The system of the present invention also provides a trading mechanism that further incorporates changes and alerts for an optimized portfolio management.

### PRIOR APPLICATION

This Application claims the benefit of U.S. Provisional Application No. 62/476,363, entitled “Rank Portfolio Management Systems” filed Mar. 24, 2017 which is hereby incorporated by reference.

### BACKGROUND

It is commonly recognized that reasonably researched diversified portfolios provide better outcomes than ones that are not or have been put together without consideration of what makes a functional and effective portfolio for intended outcomes. Constructing an effective diversified portfolio of individual equities or investment instruments is a time consuming and painstaking process, even for those seasoned in the art. The aforementioned has a multiplier effect when non-seasoned investors or individuals with less experience are concerned. Furthermore, the investments almost always bring a certain level of emotions which can negatively impact even the most astute investor, not to mention the effects on a non-seasoned investor. These knowledge and emotional handicaps form barriers to entry into investing for young non-professional investors or folks not directly involved in the art of investing. Young adults, except for those in the investment business, are easily disinterested in a process that becomes tedious and devoid of everyday mode of interactivity as is common with new applications and technological appurtenances associated with today's society. It is reasonable that a platform of mobile applications may encourage a rules-based analysis that overcomes the emotional component of investing for young and those reasonably new to the investment process. The withdrawal of emotional tie-in to investment allows investors to be objective about their portfolio and may improve the capacity to create, trade and manage functionally diversified portfolios without regard to experience level.

From the foregoing and more, it will be appreciated that what is needed in the art is a system that engages investors to objectively create, trade and manage diversified portfolios of individual equities. Such system is disclosed and claimed herein.

### SUMMARY

In one embodiment, the present invention provides a method for providing an investment product that includes a user-selected portfolio, wherein said portfolio is diversified and optimization of said diversified portfolio utilizing machine learning and artificial intelligence and assessing the readiness of the portfolio for use in investment and monitoring the returns on said investment with a continued machine learning analysis for risk management and portfolio construction, wherein the product is objectively optimized based on selected parameters for effectiveness and functionality.

In another embodiment, the method of the present invention includes the optimization components are selected from the group comprising, logic model, company ranking, rate of return, aggregation, trend, earnings, sectors, and pricing.

Another aspect of the present invention includes a logic model selection includes investment vehicles as buy and strong buys.

Another embodiment of the present invention includes a method for developing an intrinsic score for an investment vehicle by creating a watchlist of investment securities selected from at least a category wherein the at least a category include industry, ranking, trends, earnings, recommendations or combinations thereof, utilizing machine learning to provide a score based on sector and rank, wherein the score reflects an objective analysis of securities suitable for investment.

The method of the present invention includes a system wherein the intrinsic score includes a user-friendly investment variable selection process wherein all available components of at least a security are aggregated based on size, sector, rank, and a watchlist based on the selected securities.

Also, the present invention provides an investment portfolio search system, comprising identifying investment securities by CUSIP, ticker or applicable terms, utilizing parameters established by a machine learning process for optimization wherein said parameters include ranking by sector, industry, trends, wherein the search provides companies suitable to be strong buys or other categorization for optimizing an investment portfolio.

Another benefit of an embodiment of the present invention is the provision of a trading mechanism that further incorporates changes and alerts for an optimized portfolio management.

According to the present invention, a capacity is presented to a user to quickly build a portfolio of high quality individual stocks through an interactive and user-friendly interface.

The present invention provides a portfolio risk management through an alert system and thoughtful portfolio construction parameters.

A purpose of this investment platform on a mobile application, is to provide a rules-based system without the encumbrance of emotional barriers that typically plague investors, especially those new to the investment process. The present platform wherein users can effortlessly create, trade, and manage diversified portfolios of individual equities whether they are an expert or novice.

### BRIEF DESCRIPTION OF THE DRAWINGS

FIG. 1 illustrates a flow process for rules-based investing process according to the present invention.

FIG. 2 is an illustration of an example of a process for rules-based investing process according to the present invention.

FIG. 3 is an illustration of an example of a process for rules-based investing process according to the present invention.

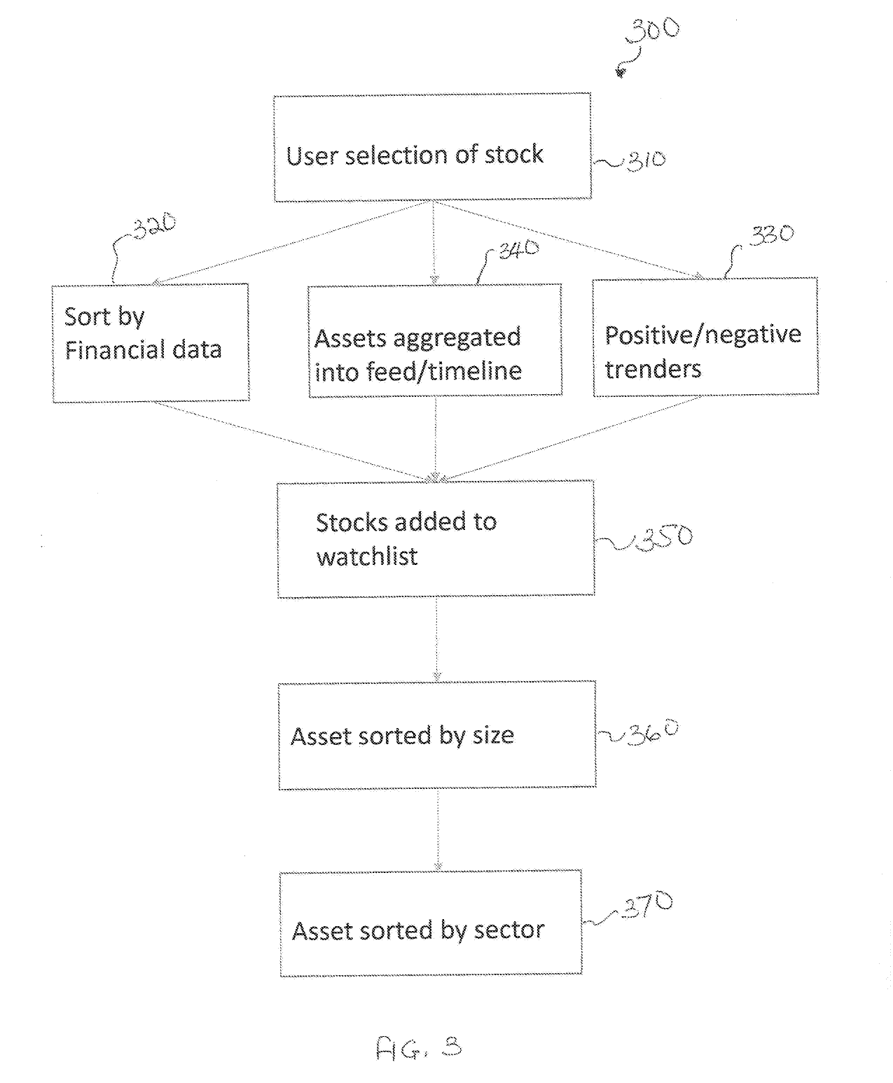

FIG. 4 is an illustration of an example of a process for rules-based investing process according to the present invention.

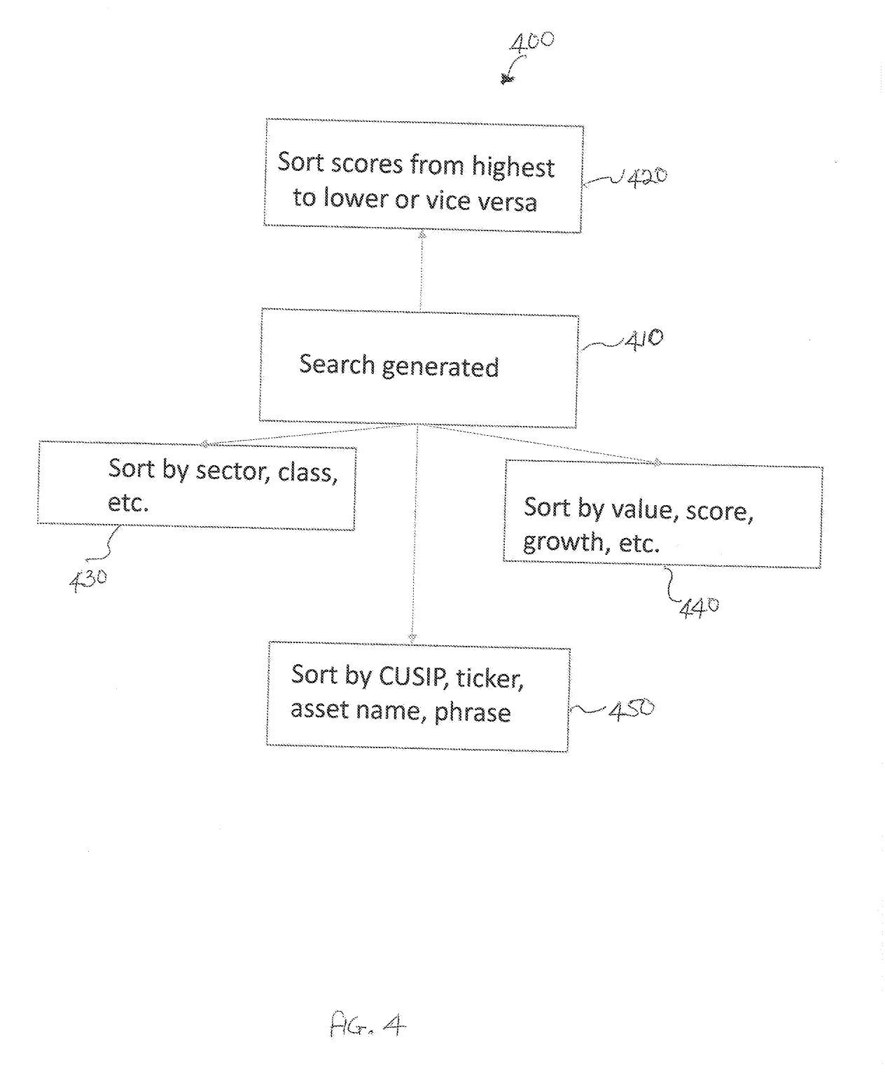

### DETAILED DESCRIPTION

In an embodiment of the present invention, a dispassionate, functional and rules-based system for creating a portfolio of equities that are preferably put together objectively, without the encumbrance of emotions. The present invention provides a system utilizing machine intelligence, sorting or ranking as a process or system based on said ranking and creating an effective diversified portfolio useful for watching and trading out of the system for an effective and beneficial portfolio management.

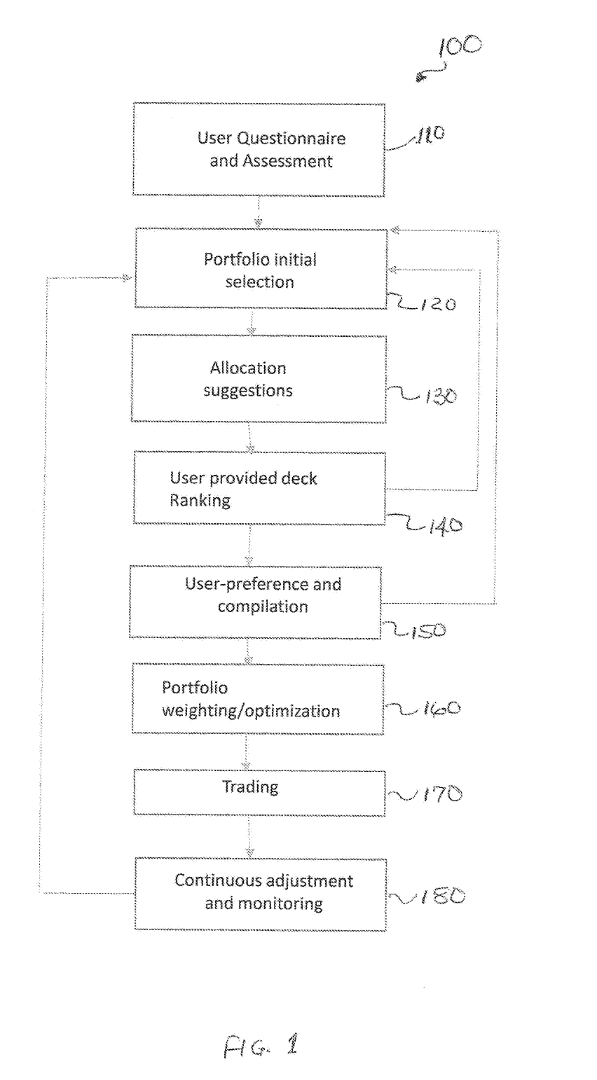

Referring to FIG. 1 is presented a flow process 100 and a reasonable or probable sequence of operation showing a step 110 wherein a user who has preferentially registered with the process or application of the present invention, is required to perform an assessment or respond to a questionnaire. The process or application of the present invention may be provided via a computer terminal, a personal digital assistant (PDA), hand-held PDA or other suitable instrument wherein the applications of the present invention are accessible. The registration with the process or application of the present invention provides a link with the back-end process of the application and may be established by the entry or documentation, however demanded, of the user's unique information, such that repeated access to the system may link a user to a back-office maintained information database.

A user may preferably respond to a questionnaire or assessment in step 110 of the present invention to provide archetypical information usable to determine the user's approach, risk tolerance, time horizon or other relevant information to indicate the type of rules-based format most appropriately suited to the user working on a process provided in the system of the present invention. A profile may preferably then be provided and generated in step 110 and may preferably optimized from a school of learning and programming that may be formed or adapted as needed to incorporate operable systems and characteristics for said rules-based system. It is reasonable to imagine, under the system of the present invention, a perpetual artificial intelligence-based analyses incorporated to provide an optimal assessment of the user profile suitable for use in an embodiment of the present invention.

Upon the establishment of a user profile via machine learning, intelligence, direct digital interaction or other suitable processes according to the present invention, step 120 provides an initial or routinized portfolio component suggestions that said user may accept or reject in an iterative transaction towards creating an effective ranked and rules-based portfolio. The suggestions for a compendium of investment vehicles, companies, or packages are generated to suit the user profile created by the user. The user may then set up to accept or reject the suggested investments as provided by the application of the present invention. If a user rejects a suggested company or investment in the selection process, such rejected investment vehicle or company is preferably recycled within the system and usable to optimize a portfolio selection, and may be presented at a later time once the underlying variables of the underlying security are more applicable to the user or situation. As an example, in one instance, a suggested portfolio component may be deemed not preferable while in another instance, it may just complement the portfolio as packaged by the user. Since several factors go into the appropriateness of an investment, suitability depends on several factors, including asset class, sector, market cap, valuation, growth characteristics, price momentum, quality, and the like.

The portfolio selection process may preferably be customized into a user-friendly process that provides as much information as practical for the electronic device usable to make such selection. As an example, such devices may include without limitation, computers, phone tablets or other information-processing or providing systems. When and where the system of the present invention incorporates the best available technology, a reasonable process may include utilization of swiping process, voice recognition, option selection or any mode adaptable or combinations thereof to provide intended outcomes. Once the portfolio is determined by the user, the system of the present invention may preferably provide suggestions or recommendations regarding allocations in step 130. Within the allocations 130 of the present invention, companies, entities or packages that make up such portfolio allocation may be presented to the user in a preferential ranking deck for the user to select or reject. As used in this disclosure, companies, entities, or packages may be used interchangeably to imply an investment unit or security that may be caused to provide a return on investment and which may allow for an investor to invest on same. Any rejected company is preferably managed within the system of the present invention for future and present optimization of suggested profiles. Such management of a rejected or even selected company may be subjected to the machine intelligence of the present invention for properties that are deemed useful for the investor or program. These properties may include, but are not limited to return on investment, projected investments, business outlook, external implication and impact on corporate stability, host of variables and ratios that are available in financial statements, and the like. The method of accepting or rejecting the companies in step 140 may be optimized to present a user-friendly mode for users as computers and application use improves.

Once the user-selection process 140 is completed, the finalization or compilation according such preference is done in step 150. An assessment of the portfolio is preferably done at this primary stage to determine how actually diversified the portfolio is, whether it is lacking in diversification or having some components, even though diversified that may need a secondary assessment. Reasonably, a needed diversification of portfolio may be lacking or present, given the limited knowledge or emotional inclination of the user. If lacking diversification, the system of the present invention may preferably optimize the provided compilation to provide diversification of such investment vehicles or companies, and to provide appropriate weighting 160 according to established system rules and machine learning or intelligence of the present invention. It is preferable that according to the system of the present invention, while the machine learning may provide options and selections, the user preferably and operably maintains a capacity to adjust or tweak the portfolios to his or her liking or preference. In some instances, the system may provide logic, reasonings or validations for incorporating suggested changes or recommendations.

After the user confirms and accepts the optimized rules-based portfolio selection, the user is preferably available or ready for trading 170 on the selected portfolio or for creating a practice portfolio. The trading 170 according to the present invention may be accomplished within the rules-based system wherein the positive return or lack thereof of the investment vehicle may be utilized for the needed optimization of the ranking system. A benefit of the present invention is the never-ending process of evaluating the investment or selection to provide an optimized return of value in the trading process. The continuous adjustment and monitoring 180 of the portfolio may preferably include interaction with the user, notification of the user when the value of worth of the investment portfolio loses or gains value enough to warrant changes or adjustments or if there is a sizeable change in ranking. When and where the investment vehicle value drops below or rises above a certain incorporated threshold, the system of the present invention may institute changes if there are included orders from the user or provide information to the user to assert the need to make changes or proceed in a manner acceptable by the user. A threshold value for a particular investment or company may be established via the machine logic or intelligence, tailored to each circumstance or user according to the present invention.

The system of the present invention utilizes an evaluation process that preferably includes an empirically sufficient and tested sequence that provides users with the confidence or assurance that highly-ranked investment vehicles would typically outperform the broader market. By broader market, we imply in this disclosure, an averaging of the Russell 3000 with dividends or any other benchmark that may be a representation of the underlying securities in question. Further, one of the challenges it eliminates is that of the user doing research on the company or companies within the investment vehicle.

The research of the present invention preferably incorporates most, if not all of the typical qualities of a good investment vehicle in highly ranked securities that may be easily accessed by a user and provide an intrinsic value score. The score, according to the present invention is preferably borne out of the compilation of values and attributes that make for a ranking system of the investment vehicle for the purpose of providing pertinent information to the user. The ranking process is preferably dynamic and may be adjusted to market conditions in order to remain robust, also serving as portfolio management tools for the user; as an example, if a stock rank increases above an included threshold, the user receives a notification, preferably pushed, thereby notifying said user of the impactful change or fluctuation occurring in their portfolios. Users may then log back into the system of the present invention and access their deck of investment vehicles to select that investment or another investment vehicle or company. User-friendliness of the system may include how to organize the information provided or assembled, how to select, swipe or click to add or delete a stock or investment that is preferable, making for ease in managing a watch list and providing a user some quick means for creating a diversified portfolio of high quality components. In addition, the system of the present invention takes securities that were added by a user and aggregates them in a general area where both the user and other participants can view the securities in order to source new ideas.

When functional, in accordance with the provisions of the present invention, a user may preferably be able to utilize a filtering tool to sort stocks by overall ranking, specific factor rank, sector rank, historical rank, and the like. This filtering tool aims to provide users a more comprehensive assessment of how their investment universe is ranked in comparison with each other from a variety of perspectives. This disclosure uses universe to imply the collection of investment instruments owned or utilized by a user in light of the combination of investment entities that would comprise a portfolio or all applicable securities in an asset class. Further, it serves as a search tool giving users the ability to identify potential candidate companies for their portfolio prior to adding them to their respective watch list. A watch list implies a collection of companies or investment opportunities that may be monitored or managed by a user to evaluate the capacity to provide expected returns on investment. A user's watchlist is preferably segmented by market value and sector, then sorted by rank, thus allowing for an efficient evaluation of a user's watchlist and the securities that make up same.

The present invention discloses the incorporation of artificial intelligence or machine learning to the investment process sufficient to provide sentiment scoring or a measure of an emotional compact to the investment process. A social inclination on investing may add information that could be found useful to bring forth a preferred quotient to humanize the investment process. Some users may only utilize investment vehicles or entities that have positive social results, such as companies whose charter meets the increasing need for a welcoming society, environmentally conscious interests, among a plethora of good corporate citizen objectives. Similar outcomes may include curating information that are pertinent to the vehicles available for investment and evaluation. In an application, such information may provide a fuller perspective on the investment targets for the user. Other aspects may include trending information on the investment vehicle or portfolio, which is preferably a result of aggregating action taken on the platform or system by users when a security is added to the watchlist or rejected therefrom, information optimization, tool applications that may include relative strength indicator for the portfolio, or execution timing to show when optimized buying or selling should be executed. The recognition of the system of the present invention includes options that may provide capacity to only select companies or investment entities that subscribe to policies that are aligned with the user, however different or unique said policies might be.

Another aspect of the present invention includes information pushed as appropriate, regarding earnings calendar, earnings surprise and announcements that may impact the user's watch list. The timing or the information contained therein may be managed or adapted via use of system learning to provide optimum data for the user to make informed decisions in the execution trades or suitable actions to meet intended objectives.

The watch list serves as a tool for portfolio construction and risk management for the user. As an example, if the user selects a US-only portfolio, the system of the present invention may select the Standard and Poor's (S&P) 500 as a benchmark. In order to limit concentration risk and provide adequate diversification of returns, the watch list may include weighting limitations. In an embodiment, if the S&P 500 weighs the technology sector as 20% of the benchmark, and the user can only hold 200 companies in the watch list and 100 companies in the portfolio (assuming or incorporating a measure of optimization as a constraint); no more than 20 technology companies could be selected or added to a portfolio from the watch list, assuming 1 percent weighting. In this manner, a user who may not need to understand or learn of the risk of overweighting a sector relative to the benchmark would be safeguarded from over-accumulation in a particular sector or under a particular category. Essentially, within 100 selections, a user would have a highly ranked, fully diversified portfolio of US equities.

Users, in accordance with the present disclosure may be able to trade directly from the platform once their watching portfolio has been constructed. A user may preferably be able to, not only trade from their existing accounts, but for those users that do not have a brokerage account, they may be able to sign up for a brokerage account on the platform and begin trading thereafter.

A benefit of the present invention is the capacity it presents to a user to quickly build a portfolio of high quality individual stocks through and interactive and user-friendly interface. Also, it is effective to have a portfolio risk managed through and alert system with detailed and thoughtful portfolio construction parameters. Another benefit that the user can have access to trade from all of the major brokerages on the system of the present invention—providing a comprehensive application—making the execution phase of the investment process seamless.

Users of the system of the present invention may generate investment ideas as the system may preferably retrieve securities that are rated favorably by the analyst community and display these ideas for the user. The user may prompt the system of the present invention to generate ideas for securities and at each instance, a new set of favorably rated investment ideas may be presented.

The following examples may provide a deeper understanding of the present invention as presented in embodiments thereof:

### Example A

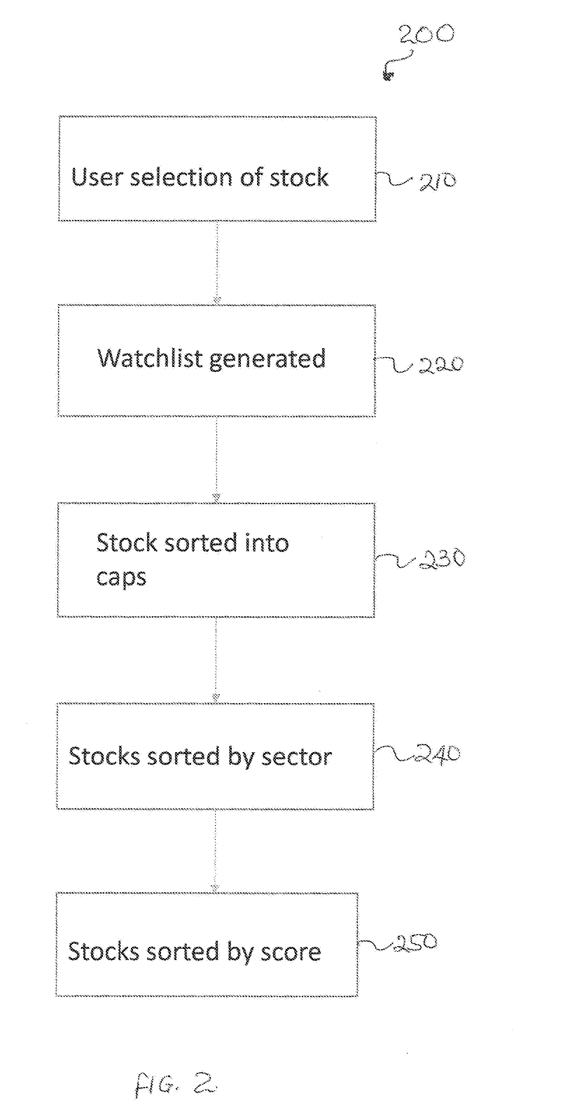

A user of the present invention subscribes and registers onto the platform of the present invention. Upon such registration as shown in FIG. 2, detailing a flow process 200 of an embodiment of the present invention, a user swipes 210 to select a stock or investment entity. Upon selection or appropriate swiping, the stock selected is pooled 220 into a watchlist of stocks that a user intends to monitor or appreciate. The selected and pooled stocks are included in a compendium that may then be sorted 230 by market cap, placed into large, mid or small cap categories. A further sorting process is then included in 240 to provide access or visibility to the sector or sectors of the market that have been selected by the user. For use and comparative ranking of the selected pool by the user, an intrinsic or other sub score 250 may then be provided to highlight the value of the portfolio for the user. Weighting system can dynamically change depending on value. Such information may then be used to build a preferred package or investment entity by the user in accordance with the disclosures of the present invention.

### Example B

In this process 300, a user with registered profile activates an item or asset list 310 and such list is sorted for financial and other analytical components 320, with the effect of that selection or activation simultaneously providing a collection 330 of the selected or rejected entities. Another outcome of the activation or selection process further provides a compendium of assets 340 that have been added to a user's timeline (aggregated to a general area—driving the company information for earning information) or list, with another set of assets added to a user-desired watchlist 350. The items in the preferred or selected watchlist are then sorted according to size 360 of the investment selected and further sorted by sector 370. This output is further useful to provide the user with tools to trade with or make informed decisions about his or her portfolio.

### Example C

In another embodiment 400 of the present invention, a search function 410 is activated for a selected or targeted investment entity or company. The search may sort 420 the entities from highest to lowest rank score, both current and historic, or related to a sub factor, or sector over a timeline of 1 month, 3 months, 6 months or such selected timeline as appropriate, and may sort the selected companies by sectors or classes 430; or further sort or search by intrinsic scores 440. Another search function may provide outcomes in the categories of CUSIP (CUSIP is an acronym that refers to Committee on Uniform Security Identification Procedures), ticker, asset name or phrases (which may be Boolean or using other logical processes). The outcome of the process of the current invention provides analytical outcomes, machine learned values that the user may use to boost and provide a highly ranked, functional and effective system in accordance with the present invention.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed:

1. A method for providing an investment product, comprising:
a user-selected portfolio, wherein said portfolio is diversified,
optimization of said diversified portfolio utilizing machine learning and artificial intelligence,
assessing the readiness of the portfolio for use in investment and monitoring the returns on said investment with a continued machine learning analysis for risk management and portfolio construction, wherein
the product is objectively optimized based on selected parameters for effectiveness and functionality.

2. The method of claim 1, wherein the optimization components are selected from the group comprising, logic model, company ranking, rate of return, aggregation, trend, earnings, sectors, and pricing.

3. The method of claim 2, wherein the logic model selection includes investment vehicles as buy and strong buys.

4. A method for developing an intrinsic score for an investment vehicle, comprising:
creating a watchlist of investment securities selected from at least a category wherein the at least a category include industry, ranking, trends, earnings, recommendations or combinations thereof,
utilizing machine learning to provide a score based on sector and rank, wherein the score reflects an objective analysis of securities suitable for investment.

5. The method of claim 4, wherein the intrinsic score includes a user-friendly investment variable selection process wherein all available components of at least a security are aggregated based on size, sector, rank, and a watchlist based on the selected securities.

6. An investment portfolio search system, comprising:
identifying investment securities by CUSIP, ticker or applicable terms,
utilizing parameters established by a machine learning process for optimization wherein said parameters include ranking by sector, industry, trends, wherein
the search provides companies suitable to be strong buys or other categorization for optimizing an investment portfolio.
